(19) United States
(12) Patent Application Publication
(10) Pub. No.: US 2002/0116665 A1
(43) Pub. Date: Aug. 22, 2002

(54) Method and apparatus for supporting software

(76) Inventors: Clifford A. Pickover, Yorktown Heights, NY (US); Paul A. Moskowitz, Yorktown Heights, NY (US); Stephen J. Boies, Mahopac, NY (US); William Grey, Millwood, NY (US)

Correspondence Address: BUCKLEY, MASCHOFF, TALWALKAR, & ALLISON, 5 ELM STREET, NEW CANAAN, CT, 06840, US

(21) Appl. No.: 09/785,572

(22) Filed: Feb. 16, 2001

(51) Int. Cl. G06F 11/00

(52) U.S. Cl. 714/38

(57) ABSTRACT

A system, method, apparatus, and computer program code for supporting software is provided. In one embodiment, a method of supporting a software program includes receiving error data identifying an error in software on a user device. A patch for the error is identified and forwarded to the user device to update the software program. The patch is identified and provided from a central service, a software provider, the patch is identified and provided locally from a data storage device of the user device.

### FIELD OF THE INVENTION

The present invention relates to software support systems. More particularly, embodiments of the present invention relate to methods, apparatus, and computer program code for automatically supporting and correcting software.

### BACKGROUND OF THE INVENTION

Despite continued and valiant efforts by software manufacturers, software users commonly encounter software errors. Errors can arise from a number of different conditions including, for example, incompatibilities between different software applications, user errors, memory errors, and the like. Often, software manufacturers produce patches or fixes to software upon learning of the error. However, it is quite difficult to disseminate these patches or fixes to thousands or even millions of geographically diverse users after they have already commenced use of the software. Typically, software manufacturers attempt to notify users of the need to upgrade or receive a patch by publicizing new releases or service packs, which interested users can download and install by, for example, visiting the manufacturer's Website. Some manufacturers, such as manufacturers of computer security software which are frequently updated to include protections against new computer viruses, install timers in the software to notify users when it is time for them to update the software. The update occurs when the user contacts a Website of the manufacturer to initiate an update.

Many users, however, do not become aware of the need for a patch until after they have experienced difficulty in operating the software. Other users never become aware of the need to update their software and simply live with defective code. It can be frustrating and inefficient for these users to encounter errors and other difficulties when operating software, particularly where a patch or fix is available. It would be desirable to provide a system and method which allows automatic correction and support of software where the user is not required to take actions to contact a manufacturer for an update or patch.

Other types of errors can occur while users operate software. For example, due to the complexity of many software packages, users may not know how to properly or most efficiently use the software. It would be desirable to provide a system and method which monitors for user inefficiencies or operational errors and which automatically provides assistance to those users.

### SUMMARY OF THE INVENTION

Embodiments of the present invention provide a system, method, apparatus, and computer program code for supporting software. In one embodiment, a method of supporting a software program includes receiving error data identifying an error in software on a user device. A patch for the error is identified and forwarded to the user device to update the software program.

According to one embodiment, the patch is identified and provided from a central service. In other embodiments, the patch is identified and provided from a software provider. In yet another embodiment, the patch is identified and provided locally from a data storage device of the user device.

According to one embodiment, the user device is monitored for errors before the error is identified. A variety of different errors may be monitored for, identified, and corrected using embodiments of the invention. For example, the error may be a user error, including a user failure to correctly or efficiently use software. The error may be a media error (e.g., a defect in a CDROM drive or other media), an application program error, or other defect.

In one embodiment, information identifying the error and information identifying a condition under which the error occurred are used to identify and provide a patch.

According to one embodiment, a patch is forwarded to the user device along with supporting information such as, for example, installation instructions, use instructions, helpful tips, or advertisements.

According to one embodiment, the patch is provided from a service provider which has access to a wide variety of patches for a number of different application programs. In one embodiment, the service provider receives payment for patches provided, e.g., from the user or from the software manufacturer.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system consistent with the present invention;

FIG. 2 is a block diagram of one embodiment of the user device depicted in FIG. 1;

FIG. 3 is a block diagram of one embodiment of the controller depicted in FIG. 1;

FIG. 4 is a tabular representation of a portion of a patch database according to an embodiment of the present invention;

FIG. 5 is a tabular representation of a portion of an instruction database according to an embodiment of the present invention;

FIG. 6 is a block diagram of one embodiment of the vendor device depicted in FIG. 1; and

FIG. 7 is a flow diagram illustrating an exemplary process for supporting software according to an embodiment of the present invention.

### DETAILED DESCRIPTION

Applicants have recognized that there is a need for a system, method, apparatus, and computer program code for supporting software systems which overcomes drawbacks of existing systems

For clarity and consistency, a number of terms are used herein. As used herein, the term “error” refers to any condition indicating a failed action of a software program including, for example: general protection faults; failed requests; hard or soft errors, and the like. Further, as used herein, the term “error” also includes user errors including user inefficiencies in operating software and/or user input errors. “Error” also refers to errors in data such as those produced by a scratch on media such as a CDROM, digital video disk (DVD), or, more generally, those present in a corrupted data file.

As used herein, the term “patch” is used to refer to code used to update, fix, or otherwise modify a software program and includes general-purpose fixes that replace or alter portions of a program. “Patch”, as used herein, also refers to code, instructions, or other information provided to a user of a user device to facilitate correction of a user error. Further, “patch” may also include data or other information used to correct a media error such as a defect on a CDROM.

Prior to a detailed description of systems, devices, and processes of the invention, an illustrative example will now be presented to facilitate understanding of embodiments of the present invention. In one embodiment, features of the present invention may be used to monitor for, detect, and correct errors in application software programs such as a word processing program operated by a user at a user device such as a home or office personal computer (PC). Embodiments of the present invention monitor operation of the PC and the word processing program to detect errors (including hard or soft application errors or user errors in operation of the program). Once an error is detected, the error is identified, and corrective action is identified. Identification of the error and the corrective action may be performed by a central service bureau (operating a controller described below), by the PC, by the software vendor, or by a combination of the entities. If a fix (such as a “patch”) is available, the fix is forwarded to the user device and installed. In some embodiments, the user or the software vendor may pay for the service (e.g., by paying a fee for each fix or a flat rate for the service).

Other types of errors may also be monitored, detected, and corrected. For example, a user operating a spreadsheet program on a PC may be inefficiently using the program when he attempts to sum a large column of numbers by individually adding each number in the column. Embodiments of the invention may be configured to monitor for such an inefficiency, and propose a fix for the inefficiency. Again, the fix may be identified and retrieved from the user's PC, from a central service bureau, from the software vendor or from a combination of the three entities. The fix may simply be instructions to the user on how to more efficiently perform the action.

These and other features will be discussed in further detail below, by first describing the system, individual devices, exemplary databases and processes according to embodiments of the invention.

System

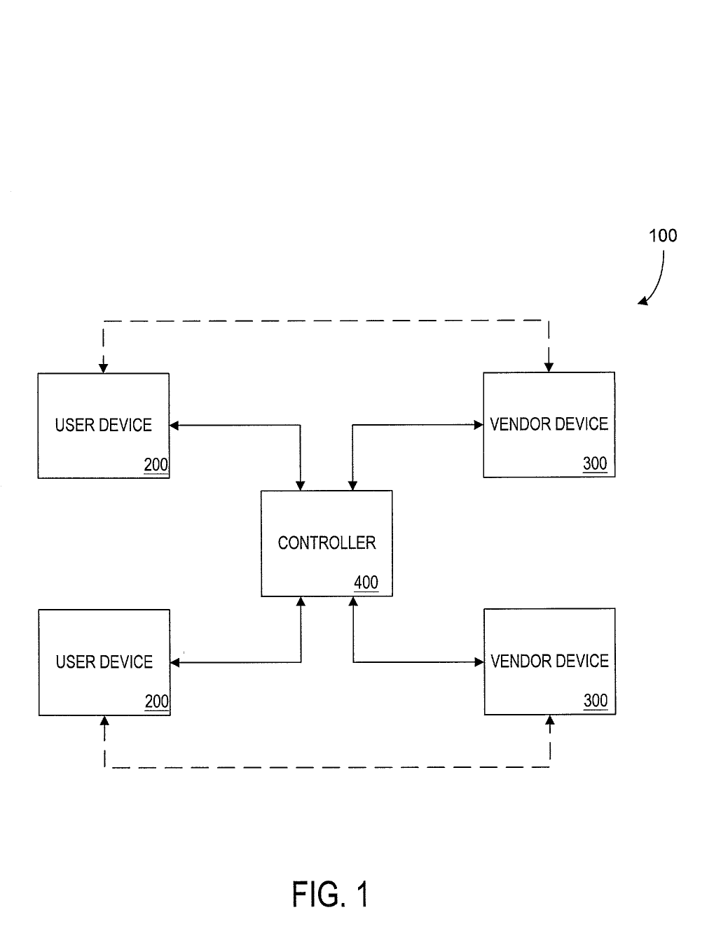

Referring first to FIG. 1, a block diagram depicting a system 100 for supporting software is shown. System 100, as depicted, includes a number of user devices 200 and a number of vendor devices 300 in communication with a controller 400. In some embodiments, one or more vendor devices 300 may communicate directly with one or more user devices 200.

In one embodiment, user devices 200 are personal computers or other computing devices operating one or more software programs such as any commercially available application program (e.g., a word processing program, a spreadsheet program, a graphics program, etc.). In operation, a user of user device 200 may experience one or more errors which disrupt his or her use of the software. According to embodiments of the present invention, these errors are detected and information about the error is forwarded to, e.g., controller 400 which uses the information to identify a patch for the error. The patch is transmitted to user device 200 to enable the user to continue to operate user device 200 with a minimal amount of disruption. In one embodiment, controller 400 is a Web-server operated by a service provider and storing and maintaining a number of different patches for one or more software manufacturers. In one embodiment, controller 400 receives patches from software vendors operating vendor devices 300. In some embodiments, vendor devices 300 may provide patches directly to user devices 200.

As used herein, devices (such as user devices 200, vendor devices 300 and controller 400) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Moreover, as used herein, communications include those enabled by wired or wireless technology.

In one embodiment of the present invention, user devices 200 and vendor devices 300 communicate with a remote, Web-based controller 400 (e.g., a server) via the Internet. Although some embodiments of the present invention are described with respect to information exchanged using a Web site, according to other embodiments information can instead be exchanged, for example, via: a direct wired or wireless telephone connection, electronic mail, a WEBTV® interface, a cable network interface, and/or a wireless communication system.

Note that although a single controller 400 is shown in FIG.1, any number of controllers 400 may be included in system 100. Similarly, any number of the other devices described herein may be included in system 100 according to embodiments of the present invention. Note that the devices shown in FIG. 1 need not be in constant communication. For example, user device 200 may only communicate with controller 400 via the Internet when appropriate (e.g., when, as described further below, an error occurs in software run on user device 200). Embodiments of each of the devices, including user device 200, vendor device 300 and controller 400 will now be described.

Devices

1. User Device

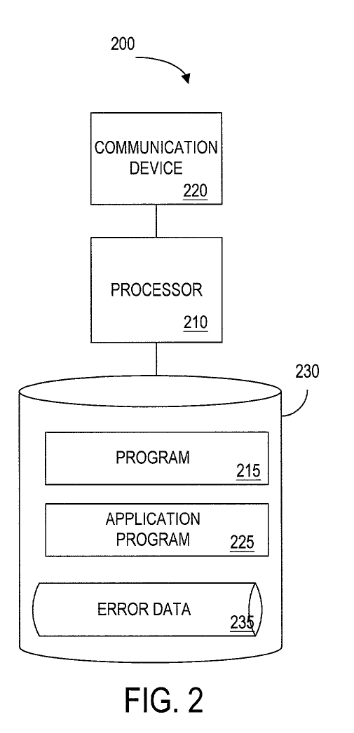

FIG. 2 illustrates an embodiment of user device 200. In one embodiment, user device 200 is a personal computer (PC) operating one or more software programs which are maintained, supported or corrected using embodiments of the present invention. User device 200 may be any device capable of performing the various functions described herein. User device 200 may be, for example: a Personal Computer (PC), a portable computing device such as a Personal Digital Assistant (PDA), a wired or wireless telephone, a one-way or two-way pager, an interactive television device, a gaming terminal (e.g., a SONY PLAY STATION® video game terminal), or any other appropriate computing, storage and/or communication device.

User device 200 comprises a processor 210, such as one or more Intel® Pentium® processors. Processor 210 is coupled to a communication port 220 through which processor 210 communicates with other devices, such as, for example, one or more controllers 300. Processor 210, via communication port 220, may also communicate with one or more remote vendor devices 300. Communication port 220 may include hardware and software facilitating communication with other devices using wired or wireless techniques, or a combination of different techniques. For example, communication port 220 may be one or more of: a network adapter, a modem, a Bluetooth chip, etc.

Processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disc and/or a hard disk. Processor 210 and data storage device 230 may each be, for example: (i) located entirely within a single computer or other computing device; or (ii) connected to each other by a remote communication medium, such as a serial port cable, telephone line or radio frequency transceiver.

Data storage device 230 stores a program 215 for controlling processor 210. Processor 210 performs instructions of program 215, and thereby operates in accordance with the present invention, and particularly in accordance with the methods described in detail herein. Program 215 may be stored in a compressed, uncompiled and/or encrypted format. Program 215 furthermore includes program elements that may be necessary, such as an operating system, a database management system and “device drivers” for allowing processor 210 to interface with computer peripheral devices. Appropriate program elements are known to those skilled in the art, and need not be described in detail herein.

Data storage device 230 also stores at least one application program 225 which may be, for example, any of a number of commercially available or custom software programs known in the art. In an example which will be used herein to describe embodiments of the invention, application program 225 is an office productivity program such as a word processing program. Upon reading this disclosure, those skilled in the art will recognize that embodiments of the present invention may be used to correct or maintain a wide variety of types of software.

According to an embodiment of the present invention, the instructions of program 215 and application program 225 may be read into a main memory from another computer-readable medium, such from a ROM to RAM. Execution of sequences of the instructions in program 215 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 230 also stores, for example, error data 235 which may be used to identify potential corrective actions which may be taken using embodiments of the present invention. For example, error data 235 may include information identifying specific error code(s) which were encountered, along with information identifying the conditions under which the error occurred. This information will be used, as will be described further below, to identify and take corrective action to fix the error. As will be described further below, some of the functionality described with respect to the controller 400 may be contained within user device 200, accordingly, some of the data described in controller 400 may be stored in data storage device 230.

2. Vendor Device

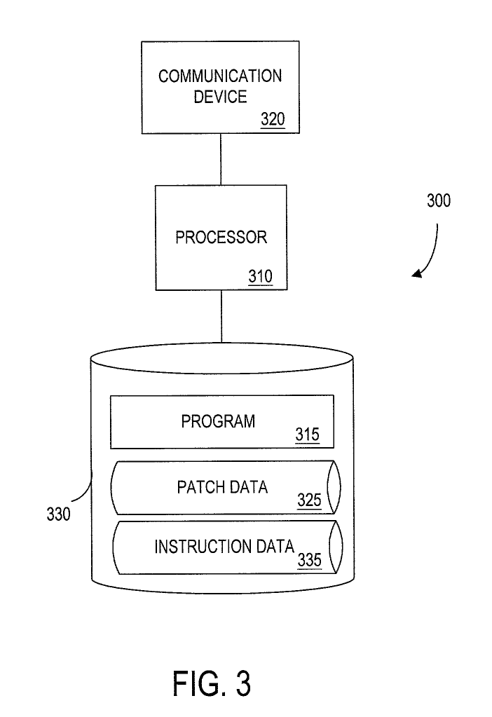

FIG. 3 illustrates an embodiment of vendor device 300. In one embodiment, vendor device 300 is a computing device, such as a server, operated by or on behalf of a software manufacturer or distributor. For example, vendor device 300 may be a Web-based server operated by a manufacturer of an application program which may be maintained, fixed, updated, and/or supported using techniques of the present invention.

Vendor device 300 may be implemented as a remote computer, a dedicated hardware circuit, an appropriately programmed general purpose computer, or any other equivalent electronic, mechanical or electromechanical device.

Vendor device 300 comprises a processor 310, such as one or more Intel® Pentium® processors. Processor 310 is coupled to a communication port 320 through which processor 310 communicates with other devices, such as, for example, one or more controllers 300. In some embodiments, vendor device 300 may communicate via communication port 320 with one or more user devices 200. Communication port 320 may include hardware and software facilitating communication with other devices using wired or wireless techniques, or a combination of different techniques. For example, communication port 320 may be one or more of: a network adapter, a modem, a Bluetooth chip, etc.

Processor 310 is also in communication with a data storage device 330. Data storage device 330 comprises an appropriate combination of magnetic, optical and/or semiconductor memory, and may include, for example, Random Access Memory (RAM), Read-Only Memory (ROM), a compact disc and/or a hard disk. Processor 310 and data storage device 330 may each be, for example: (i) located entirely within a single computer or other computing device; or (ii) connected to each other by a remote communication medium, such as a serial port cable, telephone line or radio frequency transceiver. In one embodiment, vendor device 300 may comprise one or more computers that are connected to a remote server computer for maintaining databases.

Data storage device 330 stores a program 315 for controlling processor 310. Processor 310 performs instructions of program 315, and thereby operates in accordance with the present invention, and particularly in accordance with the methods described in detail herein. Program 315 may be stored in a compressed, uncompiled and/or encrypted format. Program 315 furthermore includes program elements that may be necessary, such as an operating system, a database management system and “device drivers” for allowing processor 310 to interface with computer peripheral devices. Appropriate program elements are known to those skilled in the art, and need not be described in detail herein.

According to an embodiment of the present invention, the instructions of program 315 may be read into a main memory from another computer-readable medium, such from a ROM to RAM. Execution of sequences of the instructions in program 315 causes processor 310 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 330 also stores patch data 325 and instruction data 335. This information is used, as will be described in more detail below in conjunction with the description of data at controller 400, to identify an appropriate patch and supplemental instructions to fix an error at user device 200. Vendor device 300 and controller 400 may regularly share information to ensure that controller 400 has up to date information regarding all of the patches and fixes made available by the vendor for software manufactured by that vendor.

As will be described further below, some of the functionality described with respect to the controller 400 may be contained within user device 200, accordingly, some of the data described in controller 400 may be stored in data storage device 230.

3. Controller

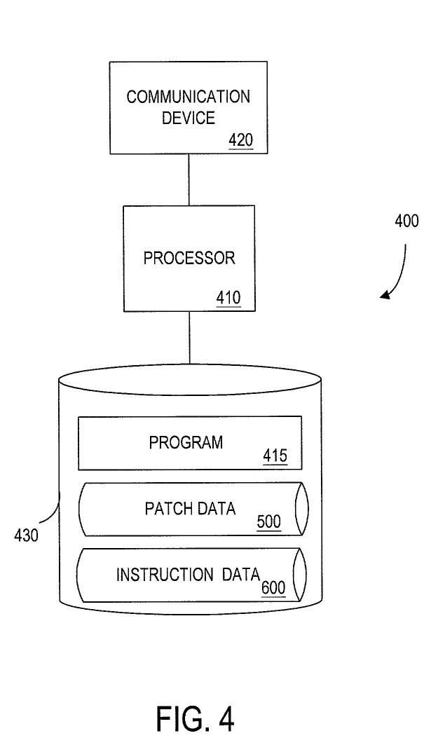

FIG.4 illustrates an embodiment of controller 400. In one embodiment, controller 400 is operated by a service provider on behalf of one or more software vendors, providers, or manufacturers to provide patches to a number of user devices 200. In one embodiment, controller 400 is a Web-based server in communication with one or more user devices 200 and one or more vendor devices 300 via a network such as the Internet. Those skilled in the art will recognize, upon reading this disclosure, that controller 400 may be implemented as a system controller, a dedicated hardware circuit, an appropriately programmed general purpose computer, or any other equivalent electronic, mechanical or electro-mechanical device capable of providing the functionality described herein.

Controller 400 comprises a processor 410, such as one or more Intel® Pentium® processors. Processor 410 is coupled to a communication port 420 through which processor 410 communicates with other devices, such as, for example, one or more user devices 200 and one or more vendor devices 300. Communication port 420 may include hardware and software facilitation communication with other devices using wired or wireless techniques, or a combination of different techniques. For example, communication port 420 may be one or more of: a network adapter, a modem, a Bluetooth chip, etc.

Processor 410 is also in communication with a data storage device 430. Data storage device 430 comprises an appropriate combination of magnetic, optical and/or semiconductor memory, and may include, for example, Random Access Memory (RAM), Read-Only Memory (ROM), a compact disc and/or a hard disk. Processor 410 and data storage device 430 may each be, for example: (i) located entirely within a single computer or other computing device; or (ii) connected to each other by a remote communication medium, such as a serial port cable, telephone line or radio frequency transceiver. In one embodiment, controller 400 may comprise one or more computers that are connected to a remote server computer for maintaining databases.

Data storage device 430 stores a program 415 for controlling processor 410. Processor 410 performs instructions of program 415, and thereby operates in accordance with the present invention, and particularly in accordance with the methods described in detail herein. Program 415 may be stored in a compressed, uncompiled and/or encrypted format. Program 415 furthermore includes program elements that may be necessary, such as an operating system, a database management system and “device drivers” for allowing processor 410 to interface with computer peripheral devices. Appropriate program elements are known to those skilled in the art, and need not be described in detail herein.

According to an embodiment of the present invention, the instructions of program 415 may be read into a main memory from another computer readable medium, such from a ROM to RAM. Execution of sequences of the instructions in program 415 causes processor 410 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Data storage device 430 also stores a patch database 500 and an instruction database 600. The patch database 500 and the instruction database 600 are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

Databases

1. Patch Database

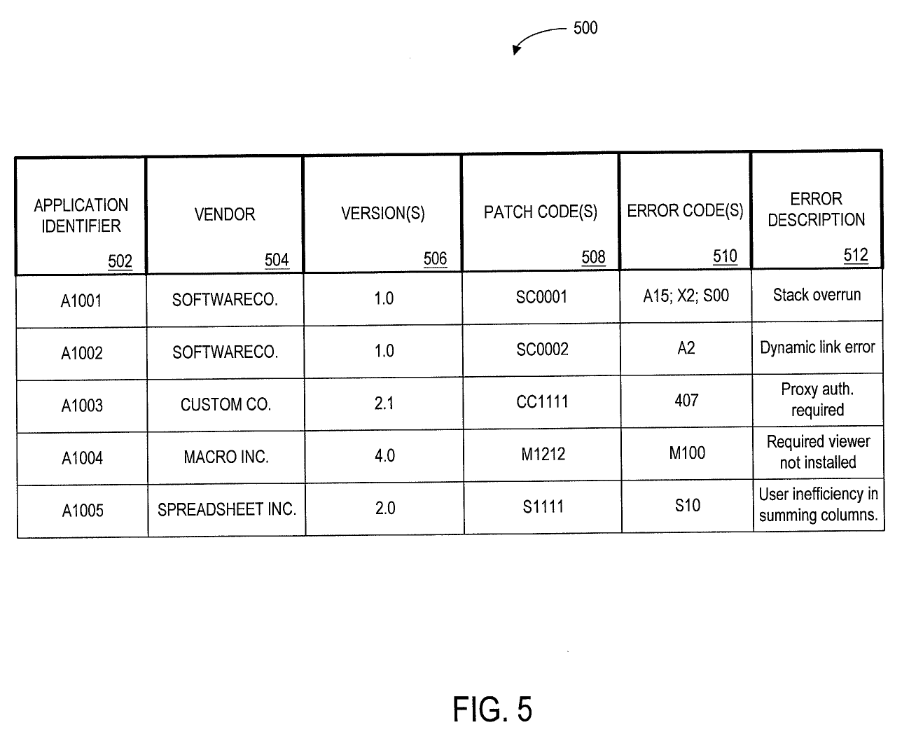

Referring to FIG. 5, a table represents patch database 500 that may be stored at controller 400 according to an embodiment of the present invention. In some embodiments, all or portions of patch database 500 may be stored at vendor device 300 and/or user device 200.

The table includes entries identifying patches which are available to correct errors that may be experienced by users of software. The table also defines fields 502, 504, 506, 508, 510, and 512 for each of the entries. The fields specify: an application identifier 502, a vendor 504, a version(s) 506, a patch code(s) 508, a error code(s) 510 and a error description 512. The information in patch database 500 may be created and updated, for example, based on information received from individual vendors 300. For example, software manufacturers may generate patches for errors in their application software and provide the patches to an entity operating controller 400 along with information identifying the types of errors that the patch corrects.

Application identifier 502 may be, for example, an alphanumeric code associated with a particular application software package which is supported using embodiments of the present invention. Application identifier 502 may be generated by, for example, individual vendors 300 or may be assigned by controller 300 to track different software programs.

Vendor 504 may be information identifying a particular vendor or manufacturer of the application software identified by application identifier 502. In the embodiment depicted in FIG. 5, only a name of the vendor or manufacturer is provided, however, other identifying information may also be provided to identify the vendor, including, for example, a corporate address, telephone number, or the like.

Version(s) 506 may be information identifying a particular version of the application software identified by application identifier 502 for which a patch is available.

Patch code(s) 508 may be information identifying a particular patch available for the application software identified by application identifier 502. Patch code(s) 508 may be assigned by, for example, a manufacturer of the software identified by application identifier 502 or it may be assigned by an entity operating controller 400. Patch code(s) 502 may be used, as will be discussed below, to retrieve information regarding a patch from information database 600.

Error code(s) 510 may be information identifying one or more error codes to which the patch identified by patch code(s) 508 is responsive. Error code(s) 510 may be any of a number of different codes including codes specified by the manufacturer of the software which has an error. Those skilled in the art appreciate that manufacturers and industry groups utilize a number of application-specific error codes as well as a number of commonly-used error codes. Any type of error code or other information used to identify the particular circumstances regarding an error condition may be used.

Error description 512 includes information identifying a description of the error identified by error code(s) 510. This information may be provided to assist in the selection of an appropriate patch in response to an error. Entries in table 500 depict various types of error descriptions.

Some or all of the information from patch database 500 may be shared with or stored at user device 200 and/or vendor device 300.

2. Instruction Database

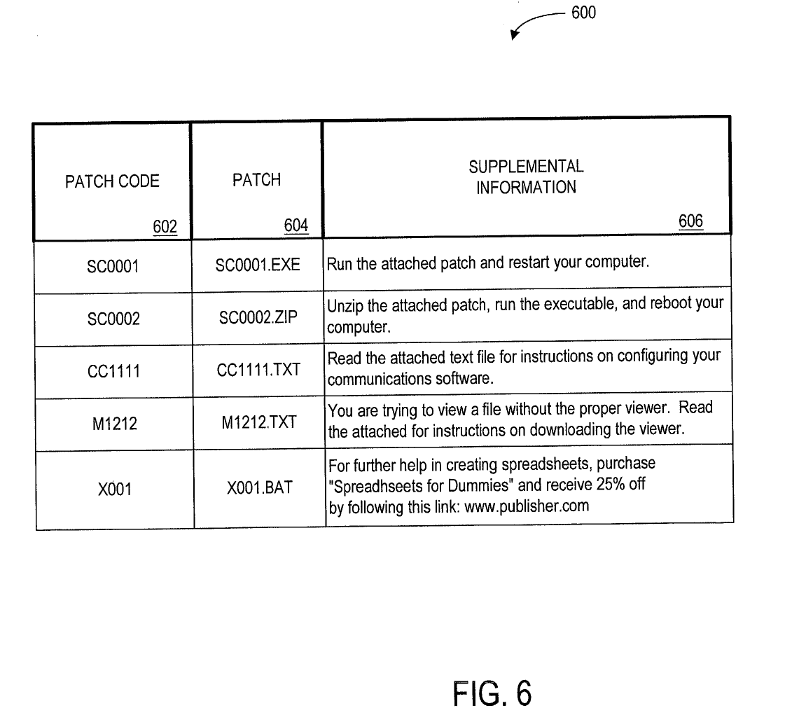

Referring to FIG. 6, a table represents information database 600 that may be stored at controller 400 according to an embodiment of the present invention. In some embodiments, all or portions of information database 600 may be stored at vendor device 300 and/or user device 200.

The table includes entries identifying information about patches which are available to correct errors that may be experienced by users of software.

The table also defines fields 602, 604, and 606 for each of the entries. The fields specify: a patch code 602, a patch 604, and supplemental information 606. The data in information database 600 may be created and updated, for example, based on information received from individual vendors 300. For example, software manufacturers may generate patches for errors in their application software and provide the patches along with information regarding the patches to an entity operating controller 400.

Patch code 602 may be based on, or related to, patch code(s) 508 of patch database 500 (FIG. 5), and is used to identify individual patches which are available in system 100.

Patch 604 includes data such as executable code that is implements the patch identified by patch code 602. Patch 604 may include, for example: a link to executable code, executable code, user instructions, or the like.

Supplemental information 606 includes information used to provide instructions or supporting information to a user operating a user device 200. This information 606 may be provided in conjunction with patch 604. Examples of different types of supplement information 606 are depicted in the table of FIG. 6. In one embodiment, supplemental information 606 may include advertising information or offers. For example, as depicted in the last row of table 600, an offer for a book related to a detected user error may be made. In this manner, embodiments of the present invention permit targeted advertising to be made to users who have particular needs. Other examples of advertisements may include offers to upgrade equipment (e.g., upgrade to a newer version of a disk drive to solve a problem with an earlier version) or software (e.g., upgrade to the next version of application software).

Some or all of the information from information database 600 may be shared with or stored at user device 200 and/or vendor device 300.

Process Description

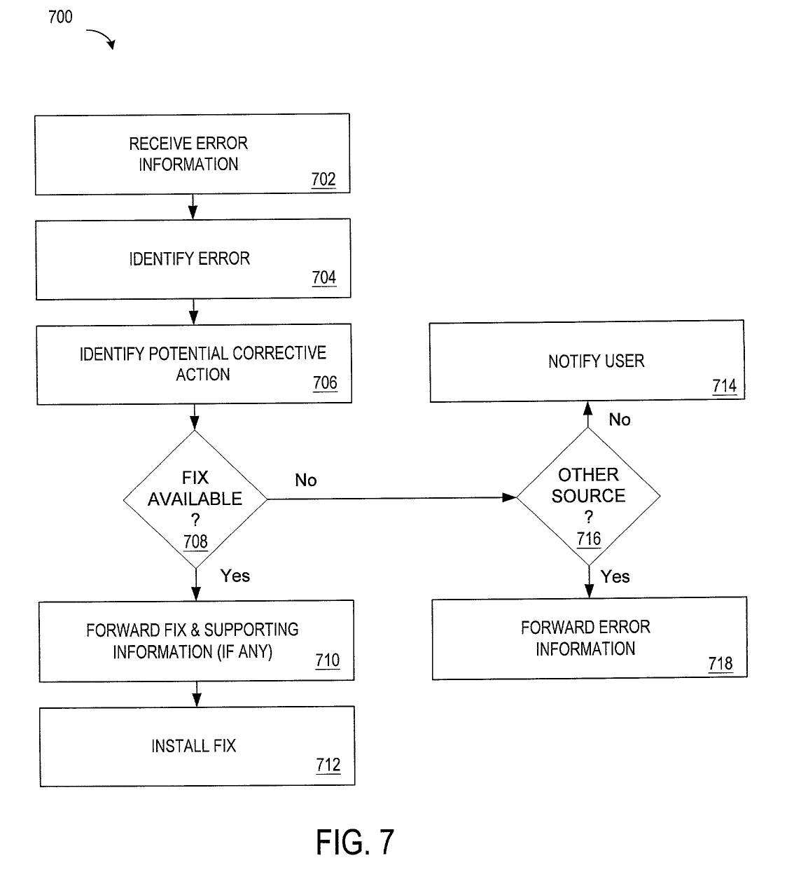

Reference is now made to FIG. 7, where a flow chart 700 is shown which represents the operation of an embodiment of the present invention. The particular arrangement of elements in the flow chart of FIG. 7, is not meant to imply a fixed order to the steps; embodiments of the present invention can be practiced in any order that is practicable. After a description of the flow chart 700, several illustrative examples will be presented to facilitate understanding of embodiments of the present invention.

Flow chart 700 depicts a process which may be performed using system 100 of FIG. 1. Processing begins at 702 when controller 400 receives error information from, e.g., user device 200. In one embodiment, this error information is detected by continually monitoring user device 200 for error conditions. This monitoring may be performed by program 215 of user device 200 (FIG. 2). Error conditions can include hard or soft application program errors or user errors (including user failures to efficiently use an application program). The error information received at 702 may include, for example, one or more error codes or other information particularly identifying the error, and information identifying condition(s) under which the error occurred.

At 704 processing continues and system 100 identifies the error experienced by user device 200. In one embodiment, this identification is performed by controller 400 by comparing the error code and/or information identifying the conditions under which the error occurred with stored error information (e.g., information in patch database 500). In other embodiments, the identification may be performed by user device 200 or vendor device 300. Once the error has been identified, processing continues at 706 where a potential corrective action is identified. In one embodiment, this involves identifying one or more patch codes (item 508 of FIG. 5) identifying one or more patches which are provided by an entity such as the manufacturer of the software to correct the error.

A determination is made at 708 whether a fix is available. If a fix is available (e.g., controller 400 is able to locate a patch code which is designed to correct the particular error which has occurred at user device 200), processing continues to 710. If a determination is made at 708 that a fix is not available, processing continues to 716 where a determination is made whether another source has a fix for the error. For example, this may involve controller 400 determining whether to forward error information to vendor 300. In some embodiments, errors may be escalated directly to the vendor of the software which caused the error condition. In some situations, the vendor may have more up to date patches than controller 400, or may simply be able to resolve more difficult errors. If controller 400 determines that another source is available to resolve the error, processing continues to 718 where the error information originally received from user device 200 (at 702) is forwarded to the other source for resolution. If processing at 716 determines that another source is not available to respond to the error, processing continues to 714 where the user is notified that system 100 has been unable to resolve the error.

If processing at 708 indicates that a fix is available, processing continues at 710 where the fix and supporting information (if any) are forwarded to user device 200. For example, this may involve identifying the patch code(s) (item 508 of FIG. 5) designed to correct the error, and forwarding the patch 604 and any supplemental information 606 (from table 600 of FIG. 6). In some embodiments, the fix may be to make an offer to the user (e.g., to upgrade equipment or software, to receive training, etc.). In other embodiments, the fix may include presentation of an advertisement in addition to a patch or user instructions.

At 712 the fix is installed at user device 200. This installation may involve some action by the user (e.g., the user may be required to follow some installation instructions, or may be instructed to take steps to more efficiently use the software program, etc.), or it may be performed with no user interaction whatsoever.

The result is a system which monitors a user device for error conditions, identifies the error, identifies corrective action, and takes the corrective action quickly and with minimal disruption of the user's interaction with the user device. In some embodiments, further steps of receiving payment are also provided. For example, in some embodiments, controller 400 may receive payment from either the user or the software vendor for each fix provided. This payment may be a set amount per fix or it may vary based on the nature of the fix. In some embodiments, advertisements or other solicitations may be provided along with the fix at 710.

Although the present invention has been described with respect to a preferred embodiment thereof, those skilled in the art will note that various substitutions may be made to those embodiments described herein without departing from the spirit and scope of the present invention.

What is claimed is:

1. A method of supporting a software program, comprising:
receiving error data for at least a first error;
identifying a patch for said at least first error; and
forwarding said patch to update said software program.

2. The method of claim 1, wherein said error data comprises:
first data identifying said at least first error.

3. The method of claim 2, wherein said first data includes an error code.

4. The method of claim 2, wherein said first data includes an error code and an application identifier.

5. The method of claim 1, further comprising:
monitoring said software program for the generation of errors; and
identifying said at least first error.

6. The method of claim 1, further comprising:
notifying a third party of said at least first error.

7. The method of claim 6, wherein said third party is a provider of said software, and said at least first error is an error in content provided by said software provider.

8. The method of claim 1, wherein said at least first error is a user error.

9. The method of claim 8, wherein said user error is a failure to properly operate said software program.

10. The method of claim 8, wherein said user error is a failure to efficiently operate said software program.

11. The method of claim 1, wherein said at least first error is a media error.

12. The method of claim 1, wherein said at least first error is an application program error.

13. The method of claim 1, wherein said patch includes executable code adapted to correct said at least first error.

14. The method of claim 1, wherein said forwarding said patch further comprises:
forwarding supporting information to said user device.

15. The method of claim 14, wherein said supporting information includes an advertisement.

16. The method of claim 14, wherein said supporting information includes a set of instructions for operating said software program.

17. The method of claim 1, further comprising:
receiving payment for said patch.

18. The method of claim 17, wherein said payment is received from a user of said user device.

19. The method of claim 17, wherein said payment is received from a provider of said software program.

20. The method of claim 2, wherein said error data further comprises:
second data identifying at least a first condition under which said at least first error occurred.

21. A device for supporting software on at least a first user device, comprising:
a processor;
a communication device, coupled to said processor, receiving error information from said at least first user device; and
a storage device in communication with said processor and storing instructions adapted to be executed by said processor to:
identify a patch for said at least first error; and
forward said patch to update said software on said at least first user device.

22. The device of claim 21, wherein said error information comprises:
first information identifying said at least first error; and
second information identifying at least a first condition under which said at least first error occurred.

23. The device of claim 22, wherein said first information includes at least an error code and an application identifier.

24. The device of claim 21, further comprising instructions adapted to be executed by said processor to:
notify a third party of said at least first error.

25. A system for supporting software, comprising:
at least a first user device having
a processor;
a communication device, coupled to said processor, configured to send and receive data over a network; and
a storage device in communication with said processor and storing instructions adapted to be executed by said processor to execute at least a first software program;
monitor said at least first software program for errors; and
forward error information about an at least first error to a controller
said controller having
a controller processor,
a controller communication device, coupled to said controller processor, configured to send and receive data over said network; and
a storage device in communication with said controller processor and storing instructions adapted to be executed by said controller processor to
receive said error information about said at least first error;
identify a patch for said at least first error; and
forward said patch to update said at least first software program on said at least first user device.

26. A computer program product in a computer readable medium for supporting a software program, comprising:
first instructions for receiving error data for at least a first error;
second instructions for identifying a patch for said at least first error; and
third instructions for forwarding said patch to update said software program.
